(19) United States
(12) Patent Application Publication
(10) Pub. No.: US 2005/0026570 A1
(43) Pub. Date: Feb. 3, 2005

(54) TDMA transceiver including Cartesian feedback loop circuit

(75) Inventor: Jae-Hee Han, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/870,890

(22) Filed: Jun. 17, 2004

(30) Foreign Application Priority Data
Aug. 2, 2003 (KR) 53619/2003

(51) Int. Cl. H04B 1/00

(52) U.S. Cl. 455/73; 455/67.11; 455/69; 455/552.1

(57) ABSTRACT

A transceiver included in a time division multiple access (TDMA) mobile station. The transceiver comprises: a transmission section for modulating and amplifying a signal to be transmitted through an antenna; a reception section for receiving a signal through an antenna and demodulating the received signal; and a feedback section for performing feedback of a transmission signal through the reception section during an operation of the transmission section and performing a linearization process, in such a manner that an output signal of the transmission section is coupled to a signal of an input terminal of the reception section and an output signal of the reception section is coupled to a signal of an input terminal of the transmission section.

### PRIORITY

This application claims priority to an application entitled “TDMA Transceiver Including Cartesian Feedback Loop Circuit” filed in the Korean Industrial Property Office on Aug. 2, 2003 and assigned Serial No. 2003-53619, the contents of which are hereby incorporated by reference.

### BACKGROUND OF THE INVENTION

1. Field of the Invention

The present invention relates generally to a time division multiple access (TDMA) transceiver, and more particularly to a TDMA transceiver including a Cartesian feedback loop circuit which can be easily realized in a mobile station.

2. Description of the Related Art

A second-generation mobile communication system provides not only a voice-centered service, but also a packet data transmission service. To this end, in the global system for mobile communications (GSM), a general packet radio service (GPRS) is introduced, which enables data to be transmitted at a maximum speed of 171 kbit/s through a GSM network.

In enhanced data rates for GSM evolution (EDGE), which was recently introduced to satisfy the increasing demand of packet transmission, the modulation method is changed from the conventional Gaussian minimum shift keying (GMSK) method to the 3 pi/8 8-PSK (phase shift keying) method, thereby enabling transmission service to be provided at a maximum speed of 473 kbit/s.

However, in the case of modulating a signal by the 3 pi/8 8-PSK, because the envelope of the signal varies according to time, it becomes impossible to use a nonlinear power amplifier which has been used in the conventional constant envelope environment.

The nonlinearity of a transmitter, mainly the nonlinearity of a power amplifier, causes adjacent channel interference (ACI) wherein the spectrum of a transmitted signal is enlarged to its neighboring channels. A solution to achieving a linear amplification is to use a power amplifier operating at an appropriate back-off below the saturation point. However, such a power amplifier has a low power efficiency and therefore is not suitable for a mobile station having a limited battery capacity. A linearization process of a power amplifier can solve this problem.

That is, because the efficiency of a power amplifier has the maximum value in the vicinity of the saturation region and is inversely proportional to linearity, the efficiency rapidly decreases when a power amplifier, as in the EDGE, is operated in a linear region. Therefore, in a case in which the use time of a battery is an important variable, as in a mobile station, an appropriate linearization mechanism must be used to enable the linearity and the efficiency to be improved at the same time. In the prior art, the Cartesian feedback loop has been used to compensate for nonlinearity caused by a power amplifier.

As described above, the Cartesian feedback loop is a necessary element for linearity in a mobile station for the EDGE. However, because the construction of the Cartesian feedback loop requires many circuit elements, it is very difficult to apply the Cartesian feedback loop to a device having such a limited size as a mobile station.

### SUMMARY OF THE INVENTION

Accordingly, the present invention has been designed to solve the above and other problems occurring in the prior art, and an object of the present invention is to provide a TDMA transceiver including a Cartesian feedback loop circuit, which can be easily realized in a mobile station.

In order to accomplish the above and other objects, the present invention provides a transceiver of a TDMA mobile station, comprising: a transmission section for modulating and amplifying a signal to be transmitted through an antenna; a reception section for receiving a signal through an antenna and demodulating the received signal; and a feedback section for performing feedback of a transmission signal through the reception section during an operation of the transmission section and performing a linearization process, in such a manner that an output signal of the transmission section is coupled to a signal of an input terminal of the reception section and an output signal of the reception section is coupled to a signal of an input terminal of the transmission section.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates a GSM type mobile communication system;

FIG. 2 illustrates a conventional Cartesian feedback loop circuit;

FIG. 3 illustrates a transceiver including a Cartesian feedback loop circuit in a single-band GSM mobile station according to a first embodiment of the present invention; and

FIG. 4 illustrates a transceiver including a Cartesian feedback loop circuit in a dual-band GSM mobile station according to a second embodiment of the present invention.

### DETAILED DESCRIPTION OF THE PREFERRED EMBODIMENT

Hereinafter, a TDMA transceiver including a Cartesian feedback loop circuit according to preferred embodiments of the present invention will be described in detail with reference to the accompanying drawings. In the following description of the present invention, a detailed description of known functions and configurations incorporated herein will be omitted when it may make the subject matter of the present invention rather unclear.

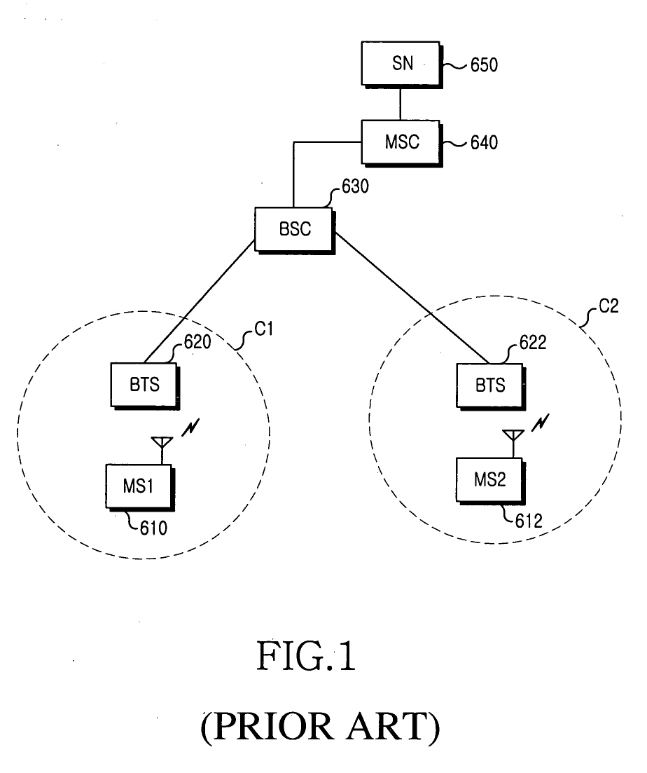

FIG. 1 illustrates a GSM type mobile communication system. The mobile communication system includes Base Transceiver Stations (BTSs) 620 and 622. The Base Transceiver Stations 620 and 622 are connected with a Base Station Controller (BSC) 630. Also, the Base Transceiver Stations 620 and 622 are wirelessly connected with mobile stations (MS) 610 and 612, which are located in corresponding cell area C1 and C2, thereby providing mobile communication service. The Base Station Controller 630 is connected with a Mobile Telephone Switching Center 640. A Service Node (SN) 650 is connected with the Mobile Telephone Switching Center 640, thereby supporting the mobile communication system with predetermined service.

As illustrated in FIG. 1, because the mobile station 610 is located in a cell C1, the mobile station 610 is provided with mobile communication service from the Base Transceiver Stations 620 through a predetermined radio channel according to the TDMA concept. A physical radio interface is divided according to a TDMA structure, that is, radio carriers are distributed into time slots. A frame comprises a plurality of continuous time slots, and a mobile station uses a physical channel, which has only one time slot, for each frame when each uplink or downlink has been established.

Such a duplex mode of the GSM is a frequency division duplex (FDD) mode, in which channels assigned to uplink and downlink exists at a predetermined frequency separation (for example, in the case of GSM900, 45 MHz). However, because a mobile station and a Base Transceiver Station transmit to each other with a predetermined time difference of time slots, transmission and reception are not performed simultaneously from the mobile station point of view.

Therefore, in the case of a system in which transmission and reception are not simultaneously performed through a TDMA transceiver such as a GSM station, the present invention provides an apparatus for linearizing the power amplifier in a transmission section by utilizing the Cartesian feedback loop using a reception section, which does not operate while the transmission section operates. Hereinafter, the Cartesian feedback loop will be described.

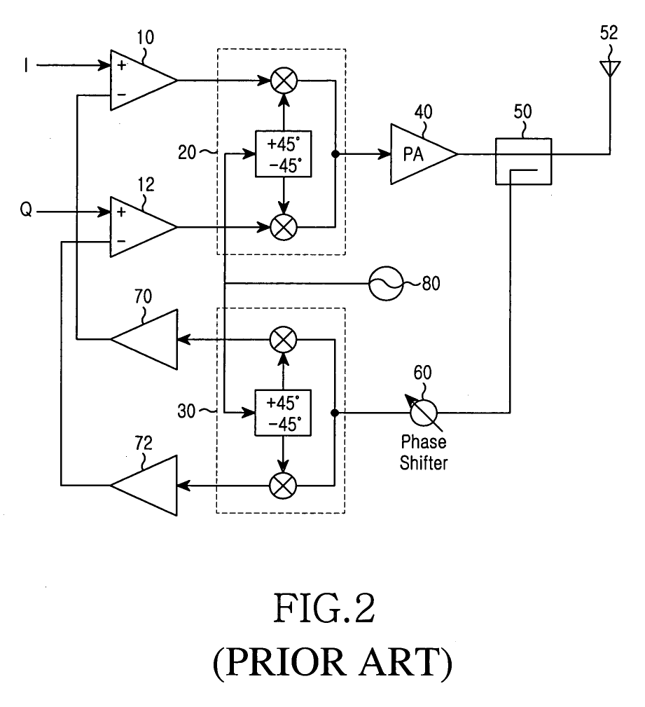

FIG. 2 illustrates the Cartesian feedback loop circuit. The Cartesian feedback loop is a kind of indirect feedback circuit, which demodulates a part of output of a power amplifier and feedbacks the demodulated output to the in phase component (hereinafter, referred to as ‘I component’) and the quadrature component (hereinafter, referred to as ‘Q component’) of baseband input terminals, thereby performing linearization.

More specifically, referring to FIG. 2, a Cartesian feedback loop circuit has a Cartesian-loop forward path and a Cartesian-loop feedback path. In the Cartesian-loop forward path, when the ‘I’ component and the ‘Q’ component of a modulation signal are applied to the Cartesian loop, a process of subtracting “I” and ‘Q’ output signals, which are applied through the feedback path, from the ‘I’ and the ‘Q’ components of the modulation signal, is performed in comparators 10 and 12. In the Cartesian-loop feedback path, the ‘I’ and the ‘Q’ components, which undergo the subtraction process, are coupled and modulated by an IQ modulator 20 and transmitted to a power amplifier 40.

Subsequently, an output signal of the power amplifier 40 is applied to the Cartesian-loop feedback path by a coupler 50. That is, a signal output from the coupler 50 is applied to a phase shifter 60. The phase shifter 60 is a phase adjustment device compensating for phase difference between a signal of the Cartesian-loop forward path and a signal of the Cartesian-loop feedback path. A signal phase-adjusted in the phase shifter 60 is demodulated by an IQ demodulator 30. Then, each of the ‘I’ and ‘Q’ components demodulated by the IQ demodulator 30 is input into corresponding comparators 10 and 12, respectively, through amplifiers 70 and 72.

According to the present invention, in a TDMA transceiver such as a GSM station in which transmission and reception are not simultaneously performed, the Cartesian feedback loop is realized using a reception section which does not operate while the transmission section operates.

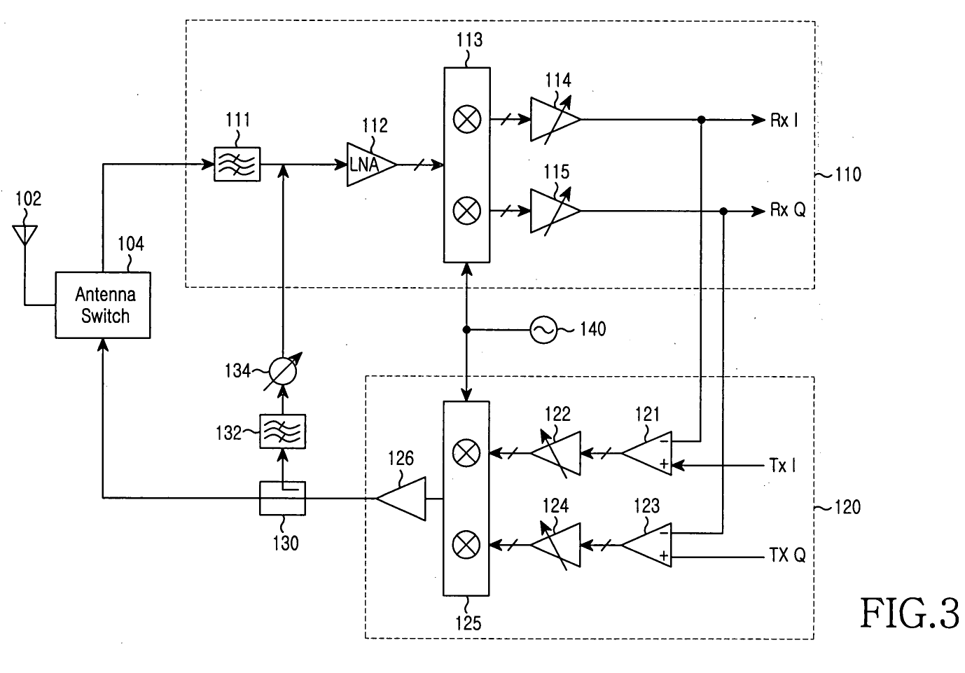

FIG. 3 illustrates a transceiver including a Cartesian feedback loop circuit in a single-band GSM mobile station according to a first embodiment of the present invention. Referring to FIG. 3, a transceiver of a single-band GSM mobile station includes an antenna switch 104 for selectively using an antenna 102 according to transmission and reception, a reception section 110 for receiving a signal, and a transmission section 120 for transmitting a signal. As generally known in the art, the reception section 110 includes a filter 111 for band-pass filtering a using signal, a low-noise amplifier 112 for amplifying a signal output through the filter 111 while having low noise, an IQ demodulator 113 for demodulating a signal output from the low-noise amplifier 112, and amplifiers 114 and 115 for amplifying each of an ‘I’ component signal and a ‘Q’ component signal output from the IQ demodulator 113. The transmission section 120 includes amplifiers 122 and 124 for amplifying each of an ‘I’ component and a ‘Q’ component to be transmitted, a modulator 125 for modulating signals output from the amplifiers 122 and 124, and a power amplifier 126 for amplifying the power of a transmission signal output from the modulator 125. A transceiver of a GSM mobile station includes a local oscillator 140 for providing local oscillation frequencies to the IQ demodulator 113 and the modulator 125.

According to the present invention, however, the transceiver of the single-band GSM mobile station includes a directional coupler 130 for feeding back a part of power output from the power amplifier 126, a band-pass filter 132 for band-pass filtering a transmission frequency, and a phase shifter 134 for adjusting the phase of a feedback signal. Also, the transceiver of the GSM mobile station includes voltage comparators 121 and 123 located at each of transmission ‘I’ and transmission ‘Q’ terminals for comparing baseband signals to have been fedback with transmission ‘I’ and transmission ‘Q’ component signals. In the present invention, the group of the elements included to perform the feedback process is defined as a “feedback section”.

In the single-band GSM mobile station according to the present invention, the output of the power amplifier 126 is input to the Cartesian-loop feedback path by the directional coupler 130. The output of the directional coupler 130 is input to the phase shifter 134 through the band-pass filter 132, which band-pass filters a transmission frequency. The phase shifter 134, as described above, compensates for phase difference between a signal of the Cartesian-loop forward path and a signal of the Cartesian-loop feedback path. The output of the phase shifter 134 is input to the low-noise amplifier 112 in the reception section 110. The output of the low-noise amplifier 112 is input to the IQ demodulator 113 in the reception section 110, so as to be demodulated. The ‘I’ component and the ‘Q’ component demodulated in the IQ demodulator 113 are input to the comparators 121 and 123, respectively, and subtracted from the transmission ‘I’ component signal and ‘Q’ component signal.

As described above, the present invention utilizes a Cartesian feedback loop using the low-noise amplifier 112, a down-conversion mixer, an amplifier, etc., which does not operate while the transmission section operates, in the reception section, thereby compensating nonlinearity caused by amplifiers of the transmission section.

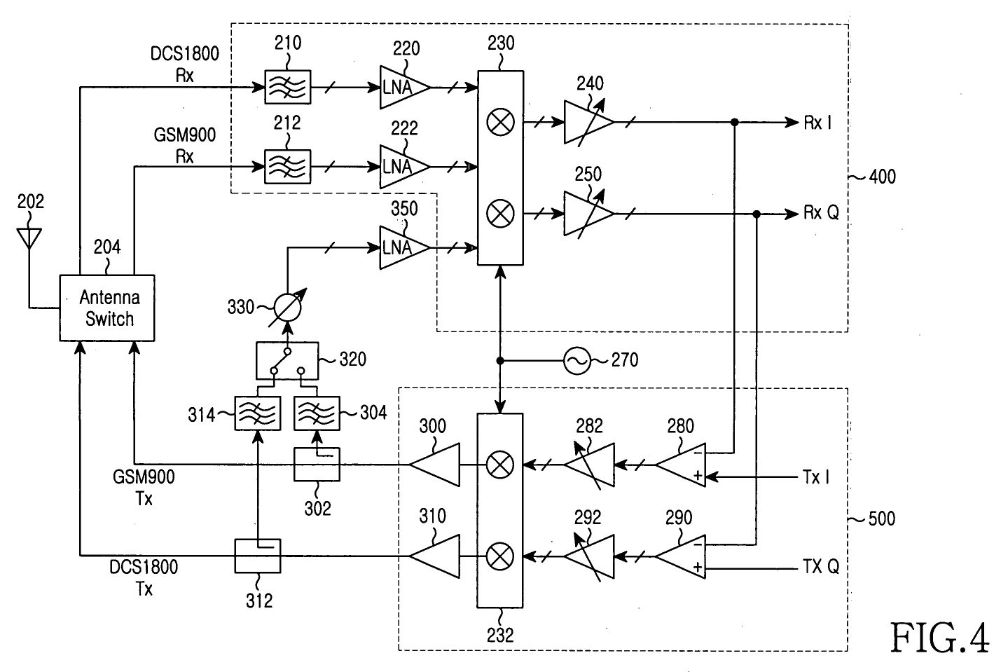

FIG. 4 illustrates a transceiver including a Cartesian feedback loop circuit in a dual-band GSM mobile station according to a second embodiment of the present invention. Herein, the operation principle of a reception section 400 and a transmission section 500 in the GSM mobile station is identical to that described in the first embodiment illustrated in FIG. 3, in which elements 240 and 250 connected to an IQ demodulator 230 in the reception section 400 are amplifiers respectively to amplify the ‘I’ component and the ‘Q’ component output from the IQ demodulator 230.

As illustrated in FIG. 4, because a dual-band GSM mobile station has two use frequency bands, each of the reception section 400 and the transmission section 500 has paths for respective frequency bands. The dual-band GSM mobile station has a feedback section for realizing a Cartesian feedback loop circuit in addition to the construction for a transceiver. The feedback section includes directional couplers 302 and 312 for feeding back a part of the power output from power amplifiers 300 and 310 of the transmission section 500, band-pass filters 304 and 314 for band-pass filtering respective transmission frequencies, and a phase shifter 330 for adjusting the phases of feedback signals. In addition, the feedback section includes an analog switch 320 for sharing a low-noise amplifier 350, and other elements for achieving a Cartesian feedback share elements included in the circuit of the reception section 400, i.e., the Cartesian feedback loop circuit shares the low noise amplifier 350 with the reception section 400. Finally, the feedback section includes voltage comparators 280 and 290, which are connected transmission ‘I’ and ‘Q’ terminals, respectively, for comparing feedback signals with baseband signals.

Hereinafter, the operation principle of the Cartesian feedback loop having the feedback section added according to the present invention will be described with reference to FIG. 4. First, when a transmission is performed, a part of the power output from a power amplifier 300 or 310 corresponding to its operation band is extracted by the directional amplifier 302 or 312, respectively. At this time, a coupling ratio must be determined as an appropriate value so as not to affect a transmission power. A signal output from the directional coupler 302 or 312 is provided to the analog switch 320 through the band-pass filter 304 or 314 corresponding to respective transmission frequency bands. The analog switch 320 is switched to a band-pass filter corresponding to the operation band. A signal input into the phase shifter 330 by the analog switch 320 is phase-adjusted to compensate phase difference between a signal of the Cartesian-loop forward path and a signal of the Cartesian-loop feedback path.

Next, a signal output from the phase shifter 330 is transmitted to the low-noise amplifier 350 to be amplified in a low noise. The low-noise amplifier 350 must be designed so as to be used in dual-band operations. A signal output from the low-noise amplifier 350 is input into the IQ demodulator 230 of the reception section 400 to be demodulated. The ‘I’ component signal and the ‘Q’ component signal, which are demodulated by the IQ demodulator 230, are amplified by amplifiers 240 and 250, and input into the comparators 280 and 290, so as to be subtracted from the transmission ‘I’ and ‘Q’ baseband signals.

According to the present invention, because a Cartesian feedback loop is constituted in a TDMA mobile station using the existing reception section, a linearization circuit of a power amplifier can be constructed by adding only a few elements, and thereby a Cartesian feedback loop can be realized in a minimum area without a heavy burden of additional expenses.

While the present invention has been shown and described with reference to a case in which the present invention is applied to a GSM mobile station, the present invention can also be applied to all mobile stations of TDMA communication system, which uses different time slots from each other for transmission and reception.

Also, it will be understood by those skilled in the art that various changes in form and details may be made therein without departing from the spirit and scope of the present invention as defined by the appended claims. Accordingly, the scope of the invention is not to be limited by the above embodiments but by the claims and the equivalents thereof.

1. A transceiver included in a time division multiple access (TDMA) mobile station, the transceiver comprising:
a transmission section for modulating and amplifying a transmission signal to be transmitted through an antenna;
a reception section for receiving a reception signal through an antenna and demodulating the received signal; and
a feedback section for performing feedback of the transmission signal through the reception section during an operation of the transmission section and performing a linearization process;
wherein an output signal of the transmission section is coupled to a signal of an input terminal of the reception section and an output signal of the reception section is coupled to a signal of an input terminal of the transmission section.

2. The transceiver as claimed in claim 1, wherein the reception section comprises:
a band-pass filter for band-pass filtering the reception signal received through the antenna;
a low-noise amplifier for amplifying the reception signal output from the band-pass filter; and
a demodulator for demodulating the reception signal output from the low-noise amplifier.

3. The transceiver as claimed in claim 1, wherein the transmission section comprises:
a modulator for modulating the transmission signal to be transmitted through the antenna; and
a power amplifier for amplifying the transmission signal output from the modulator.

4. The transceiver as claimed in claim 1, wherein the feedback section comprises:
a directional coupler for enabling an output of a power amplifier of the transmission section to be fedback to the reception section;
a band-pass filter for band-pass filtering the output of the directional coupler to obtain a transmission frequency band;
a phase shifter for phase-adjusting the signal filtered through the band-pass filter and outputting the phase-adjusted signal to an input terminal of a low-noise amplifier in the reception section; and
a comparator for comparing an output signal of a demodulator of the reception signal with the transmission signal to be transmitted through the antenna.

5. The transceiver as claimed in claim 1, wherein the TDMA mobile station operates in dual frequency bands, and the feedback section comprises:
two directional couplers for enabling signals output from power amplifiers of each band in the transmission section to be fedback to the reception section;
two band-pass filters for band-pass filtering the signals output from the two directional couplers;
an analog switch for selecting one of the signals output from the two band-pass filters;
a phase shifter for phase-adjusting and outputting the signal output from the band-pass filter connected by the analog switch;
a low-noise amplifier for amplifying the signal output from the phase shifter and outputting the amplified signal to a demodulator of the reception section; and
a comparator for comparing an output signal of the demodulator with the transmission signal to be transmitted through the antenna.
